(19) United States
(12) Patent Application Publication
(10) Pub. No.: US 2002/0165327 A1
(43) Pub. Date: Nov. 7, 2002

(54) Solvent cast optical film

(76) Inventors: Gabrie Hoogland, Breda (NL); Robert Puyenbroek, Bergen op Zoom (NL); Hendrik Ralph Patrick Ritter, Best (NL); Safwat E. Tadros, Evansville, IN (US); Kang Xi, Terre Haute, IN (US)

Correspondence Address: Robert E. Walter, GE Plastic, One Plastics Avenue, Pittsfield, MA, 01201, US

(21) Appl. No.: 09/826,723

(22) Filed: Apr. 5, 2001

(51) Int. Cl. C08F 283/00

(52) U.S. Cl. 525/461

(57) ABSTRACT

Disclosed is a low birefringence solvent cast film of optical quality comprising a blend of a cycloaliphatic polyester and a polycarbonate and method of preparing the film by casting a solvent containing dissolved cycloaliphatic polyester and a polycarbonate onto a support and evaporating the solvent to form a film.

### FIELD OF THE INVENTION

This invention relates to solvent cast transparent thermoplastic films of optical quality.

### BACKGROUND OF THE INVENTION

Use of optical storage devices has become common since the advent of the compact disc (CD) widely used for the storage of music, video and other information. Optical storage devices of this type require a transparent substrate with excellent optical properties. This substrate is encoded with information often by molding in a series of pits or depressions. Suitably coated this substrate can be read by a laser to give a series of signals recovering the information stored on the disc. With storage devices of this type, there is a growing need to store more and more information in a smaller space.

Bisphenol A Polycarbonate (BPA-PC) has been widely used for optical storage media applications, however, BPA-PC has some limitations. It is rather difficult to process by injection molding which limits the speed with which discs can be made and the quality and amount of information that can be stored on them. In these applications BPA-PC and optical data storage devices made from it are limited by their birefringence. Birefringence, resulting from the inherent properties of the resin and also from how it was processed (influenced by its Theological properties) can interfere with the recovery of information stored on the device (i.e. disc).

Structural variations of BPA-PC have been made to deal with the birefringence limitations of BPA-PC but many of them do not fully meet the other requirements for a successful optical data storage device material. They are either too brittle, have poor optical properties (low transmittance and /or high haze), or are difficult to process due to their high glass transition temperature (Tg). High processing temperature can also lead to degradation of the polymer chain leading to loss of mechanical properties, color formation (especially yellowing) and generation of gaseous by-products impairing optical properties. Other potential optical materials of low birefringence do not meet the needs of an optical storage device because they are too floppy (have a flex modulus below about 150,000 psi) or have a low thermal capability (Tg below about 80° C.).

Therefore, there is a need to prepare resin compositions and articles made from them that are transparent, have low birefringence and good melt processability.

There are several patents describing specific types of aromatic polycarbonate with improved optical properties or higher thermal capability.

Polycarbonates of a specific molecular weight range with at least one pendant aromatic group and an optical disc substrate made thereof are claimed by M. Hasuo et al. in U.S. Pat. No. 4,734,488. These materials are shown to have superior heat resistance (higher Tg) than polycarbonate along with good optical properties.

U.S. Pat. No. 4,680,374 claims an optical substrate with double refraction not greater than 5×10−5 made of a polycarbonate copolymer of aliphatic substituted bisphenols. U.S. Pat. No. 5,561,180 to Taketani et al. describe polycarbonate film having optical properties which is cast from a solvent.

Polycarbonate polymers and copolymers of spiro dihydric phenols and their preparation are disclosed by V. Mark in U.S. Pat. No. 4,552,949 as exhibiting improved heat distortion and retaining transparency. The chain stiffness of these types of polycarbonates is discussed by R. Wimberger-Friedl, M. G. T. Hut and H. F. M. Schoo in Macromolecules, 29, 5453-5458 (1996).

Specific spiro biindane aliphatic diacid copolymers are disclosed as having low birefringence in published EP 846711-A2 entitled Optical Disk grade Copolyestercarbonates Derived from Hydroxyphenyl Indanols.

There are references to transparent blends of aromatic polycarbonates with specific cycloaliphatic polyesters but none address birefringence or the requirements of optical storage devices.

U.S. Pat. No. 4,188,314 describes shaped articles (such as sheet and helmets) of blends of 25-98 parts by weight (pbw) of an aromatic polycarbonate and 2-75 pbw of a poly cyclohexane dimethanol phthalate where the phthalate is from 5-95% isophthalate and 95-10% terephthalate. Articles with enhanced solvent resistance and comparable optical properties and impact to the base polycarbonate resin and superior optical properties to an article shaped from a polycarbonate and an aromatic polyester, such as polyalkylene terephthalate, are disclosed.

There are other patents that deal with polycarbonate polycyclohexane dimethanol phthalate blends for example; U.S. Pat. Nos. 4,125,572; 4,391,954; 4,786,692; 4,897,453 and 5,478,896. U.S. Pat. No. 5,478,896 relates to transparent polycarbonate blends with 10-99% polyester of CHDM with some minor amount of aliphatic diol and iso and terephthalic acid. U.S. Pat. No. 4,786,692 relates to a 2-98% aromatic polycarbonate blend with a polyester made of cyclohexane dimethanol (CHDM) and ethylene glycol (EG) in a 1:1 to 4:1 ratio with iso and terephthalic acid. U.S. Pat. No. 4,391,954 describes compatible compositions of non halogen polycarbonate (PC) and amorphous polyesters of CHDM and a specific iso/tere phthalate mixture. U.S. Pat. No. 4,125,572 relates to a blend of 40-95% PC, 5-60% polybutylene terephthalate (PBT) 1-60% and 1-60% an aliphatic/cycloaliphatic iso/terephthalate resin. U.S. Pat. No. 4,897,453 describes blends of 10-90% PC, 10-90% of a polyester of 0.8-1.5 IV, comprised of 1,4-cyclohexane dicarboxylic acid, 70% trans isomer, CHDM and 15-50 wt. % poly oxytetramethylene glycol with 0-1.5 mole % branching agent. Also claimed are molded or extruded articles of the composition. None of these references raise, suggest, or address the question of birefringence and the special needs for an optical data storage material.

### SUMMARY OF THE INVENTION

There is a need for substrates or films of optical quality, that are transparent, easy to form and have low birefringence.

A solvent cast low birefringence substrate or film of optical quality comprises a blend of a cycloaliphatic polyester and a polycarbonate. The film is prepared by casting solvent containing dissolved cycloaliphatic polyester and a polycarbonate onto a support and evaporating the solvent to form a substrate or film.

Blends of poly cycloaliphatic polyesters and polycarbonates give transparent compositions which have reduced Tgs compared to the polycarbonate (indicative of improved processability) and articles made from them have low birefringence.

Poly cycloaliphatic polyesters generally have low Tgs and high birefringence however, their blends with polycarbonates give transparent articles with reduced birefringence (compared to the base polyester).

Typically, casting films of polycarbonate require high molecular weights on the order of 40,000 to 250,000g/mol be within a desirable viscosity range for solvent casting.

With the present invention, lower molecular weight polycarbonate, from about 25,000 to about 30,000g/mol may be utilized. The molecular weight of the cycloaliphatic polyester is preferable from 65,000 to 75,000, more preferably about 70,000g/mol, with the resulting blend having a viscosity from 5,000 to 10,000 centipoise which is at the lower specification limits of the solvent cast process.

### DETAILED DESCRIPTION OF THE INVENTION

We have found that the blends of aromatic polycarbonate with cycloaliphatic polyesters such as polycyclohexane dimethanol cyclohexy dicarboxylate (PCCD) are transparent and have excellent melt flow property that can be solvent cast into films with surprisingly low birefringence. Certain compositions of polycarbonate (PC) blends containing PCCD can be used to make low birefringence extruded film. Ratios of about 50:50 to about 70:30 PC to PCCD are especially useful for their good optical properties, easy of process, and practical heat resistance. To overcome gauge, and optical defect limitations inherent to the melt-extrusion process, a solvent cast defect free isotropic film with good surface properties is gained by casting a solution containing 5 to 40 parts by weight of the PC/PCCD compositions in a suitable solvent.

In the production of such film, suitable solvents desirable dissolve the PC and PCCD components. Typical solvents comprise halogenated hydrocarbons such as methylene chloride, halogen-free solvents such a tetrahydrofuan, cyclohexanone and dioxane. It is contemplated that mixtures of solvents may be utilized. A solution of 30 to 70% by weight of methylene chloride and the remaining amount being PC and PCCD may be utilized. Colored PC/PCCD films are prepared by dissolving or dispersing dyes and pigments in amount of colorant from about 5 to about 20 parts per weight into the solvent containing 5 to 40 parts per weight on the PC/PCCD composition.

A film is produced by casting the solution containing PC/PCCD onto a support which is heated to evaporate the solvent. For example, methylene chloride boils at 40 degrees Centigrade and dioxolane at 76 degrees Centigrade. The support may be for example, glass, stainless steel or ferrotype plate, or a plastic film. For a production process, PC/PCCD compositions are dissolved in a solution and casted on an endless polished belt and dried to a certain volatile content. The solution layer may be adjusted to a desired uniform thickness on the support by sweeping the layer with a doctor blade and using techniques known in the art such a a reverse roll coater or casting from a die. Thin films may be retained with no flow line problems on the surface, no blackspecs and gels in the film. Through this production process anisotropic films can be obtained, leading to films with low birefringencies.

Birefringence is an important property of molded optical parts of the present invention. The in-plane birefringence (IBR) is critical to the performance of an optical disc and is defined as the phase retardation experienced by light as it travels through an optical part. IBR is influenced by the optical and rheological properties of the material. IBR is measured by illuminating a part of thickness d with polarized light with wavelength I at normal incidence and using a variable phase retarder, such as a Soliel-Babinet compensator, with a linear polarizer to determine the phase shift, D, experienced by the light as it travels through the part. The IBR is the phase shift expressed in units of nanometers and is related to the refractive index difference in the radial (nr) and tangential (nt) directions.

$$IBR ≡ \frac{Δ}{2 π} λ = d ( {n}_{r} - {n}_{t} )$$

Another key property in optical data storage, particularly magneto-optical storage, is vertical birefringence (VBR). VBR is defined as the difference between the refractive index in the plane of the part (nr) and that perpendicular to the plane (nz). VBR of an optical substrate is influenced by the optical properties of the material. It is measured by finding the retardation experienced by a laser beam as it traverses a part at normal incidence and the retardation at non-normal (but known) incidence. Comparison of the two numbers allows calculation of nr-nz. VBR is dimensionless and is typically expressed on a scale of 10-6.

A third parameter for optical materials is Cg which is the stress-optical coefficient of material in the glassy state. It can be measured with a molded part such as a small bar or disc. Birefringence can be measured by the methods described above. When a stress (s) is applied to the bar, the birefringence will change by an amount, B. The stress-optical coefficient, which has units of Brewsters, is given by:

B=C_{g}σ

Taken together or separately lower IBR, VBR and Cg values indicate superior optical properties. These properties are especially important in the storage and retrieval of information using optical methods. As these storage and retrieval methods move to increasingly finer scale, the birefringence properties of a material and an article made from it become very important.

Low birefringence is defined as: In-Plane Birefringence (IBR) from −100 to +100 nanometers (nm); Vertical Birefringence (VBR) less than or equal to 300×10−6 and a stress optical coefficient (Cg) less than or equal to 70 Brewsters.

In order to further enhance performance in optical storage devices, acidic phosphorus based stabilizers are useful to retard melt reaction of the cycloaliphatic polyester and polycarbonate resin and improve color.

The most preferred materials will be blends where the polyester has both cycloaliphatic diacid and cycloaliphatic diol components specifically polycyclohexane dimethanol cyclohexyl dicarboxylate (PCCD).

The preferred polycarbonate will be composed of units of BPA, SBI bis phenol, aryl substituted bisphenols, cycloaliphatic bisphenols and mixtures thereof.

The ratio of cycloaliphatic polyester to polycarbonate in the range of 40:60 to 5:95% by weight of the entire mixture is preferred. Mixtures from 50:50 to 30:70 are most preferred.

The cycloaliphatic polyester resin comprises a polyester having repeating units of the formula I:

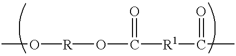

where at least one R or R1 is a cycloalkyl containing radical.

The polyester is a condensation product where R is the residue of an aryl, alkane or cycloalkane containing diol having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof with the proviso that at least one R or R1 is cycloaliphatic. Preferred polyesters of the invention will have both R and R1 cycloaliphatic.

The present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

The polyester resins are typically obtained through the condensation or ester interchange polymerization of the diol or diol equivalent component with the diacid or diacid chemical equivalent component.

R and R1 are preferably cycloalkyl radicals independently selected from the following formula:

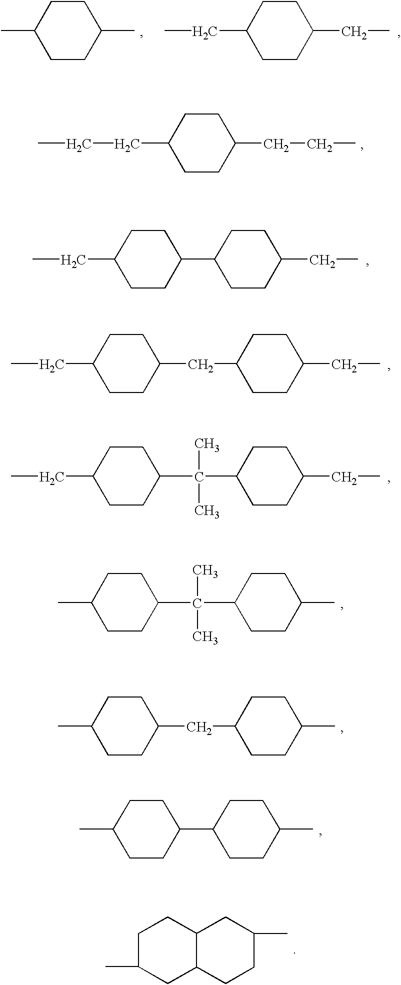

The preferred cycloaliphatic radical R1 is derived from the 1,4-cyclohexyl diacids and most preferably greater than 70 mole % thereof in the form of the trans isomer. The preferred cycloaliphatic radical R is derived from the 1,4-cyclohexyl primary diols such as 1,4-cyclohexyl dimethanol, most preferably more than 70 mole % thereof in the form of the trans isomer.

Other diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol-1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins of the present invention preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. They may also be prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl-1,4-cyclohexane-dicarboxylate.

A preferred cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula II:

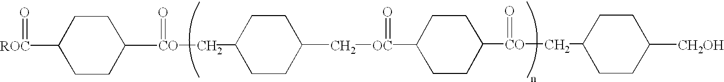

With reference to the previously set forth general formula, for PCCD, R is derived from 1,4 cyclohexane dimethanol; and R1 is a cyclohexane ring derived from cyclohexanedicarboxylate or a chemical equivalent thereof. The favored PCCD has a cis/trans formula.

The polyester polymerization reaction is generally run in the melt in the presence of a suitable catalyst such as a tetrakis (2-ethyl hexyl) titanate, in a suitable amount, typically about 50 to 200 ppm of titanium based upon the final product.

The preferred aliphatic polyesters used in the present transparent molding compositions have a glass transition temperature (Tg) which is above 50° C., more preferably above 80° C. and most preferably above about 100° C.

Also contemplated herein are the above polyesters with from about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

Polycarbonates useful in the invention comprise the divalent residue of dihydric phenols, Ar′, bonded through a carbonate linkage and are preferably represented by the general formula III:

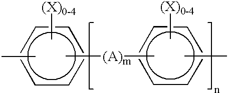

wherein A is a divalent hydrocarbon radical containing from 1 to about 15 carbon atoms or a substituted divalent hydrocarbon radical containing from 1 to about 15 carbon atoms; each X is independently selected from the group consisting of hydrogen, halogen, and a monovalent hydrocarbon radical such as an alkyl group of from 1 to about 8 carbon atoms, an aryl group of from 6 to about 18 carbon atoms, an arylalkyl group of from 7 to about 14 carbon atoms, an alkoxy group of from 1 to about 8 carbon atoms; and m is 0 or 1 and n is an integer of from 0 to about 5. Ar′ may be a single aromatic ring like hydroquinone or resorcinol, or a multiple aromatic ring like biphenol or bisphenol A.

The dihydric phenols employed are known, and the reactive groups are thought to be the phenolic hydroxyl groups. Typical of some of the dihydric phenols employed are bis-phenols such as bis(4-hydroxyphenyl)methane, 2,2-bis(4-hydroxyphenyl)propane (also known as bisphenol-A), 2,2-bis(4-hydroxy-3,5-dibromo-phenyl)propane; dihydric phenol ethers such as bis(4-hydroxyphenyl)ether, bis(3,5-dichloro4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl)sulfone, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl)sulfide, bis(4-hydroxyphenyl)sulfoxide and bis(3,5-dibromo4-hydroxyphenyl)sulfoxide. A variety of additional dihydric phenols are available and are disclosed in U.S. Pat. Nos. 2,999,835, 3,028,365 and 3,153,008; all of which are incorporated herein by reference. It is, of course, possible to employ two or more different dihydric phenols or a combination of a dihydric phenol with a glycol.

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishalofqrmates of glycol, and the like. While all of the above carbonate precursors are useful, carbonyl chloride, also known as phosgene, and diphenyl carbonate are preferred.

The aromatic polycarbonates can be manufactured by any processes such as by reacting a dihydric phenol with a carbonate precursor, such as phosgene, a haloformate or carbonate ester in melt or solution. U.S. Pat. No. 4,123,436 describes reaction with phosgene and U.S. Pat. No. 3,153,008 describes a transesterification process.

Preferred polycarbonate will be made of dihydric phenols that result in resins having low birefringence for example dihydric phenols having pendant aryl or cup shaped aryl groups like:

Phenyl-di(4-hydroxyphenyl) ethane (acetophenone bisphenol):

Diphenyl-di(4-hydroxyphenyl) methane (benzophenone bisphenol):

2,2-bis(3-phenyl-4-hydroxyphenyl) propane

2,2-bis-(3,5-diphenyl-4-hydroxyphenyl) propane;

bis-(2-phenyl-3-methyl-4-hydroxyphenyl) propane;

2,2′-bis(hydroxyphenyl)fluorene;

1,1-bis(5-phenyl-4-hydroxyphenyl)cyclohexane;

3,3′-diphenyl-4,4′-dihydroxy diphenyl ether;

2,2-bis(4-hydroxyphenyl)-4,4-diphenyl butane;

1,1-bis(4-hydroxyphenyl)-2-phenyl ethane;

2,2-bis(3-methyl-4-hydroxyphenyl)-1-phenyl propane;

6,6′-dihdyroxy-3,3,3′,3′-tetramethyl-1,1′-spiro(bis)indane;

(hereinafter “SBI”), or dihydric phenols derived from Spiro biindane of formula IV:

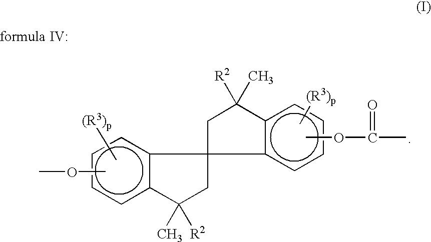

Units derived from SBI and its 5-methyl homologue are preferred, with SBI being most preferred.

Other dihydric phenols which are typically used in the preparation of the polycarbonates are disclosed in U.S. Pat. Nos. 2,999,835, 3,038,365, 3,334,154 and 4,131,575. Branched polycarbonates are also useful, such as those described in U.S. Pat. Nos. 3,635,895 and 4,001,184. Polycarbonate blends include blends of linear polycarbonate and branched polycarbonate.

It is also possible to employ two or more different dihydric phenols or a copolymer of a dihydric phenol with an aliphatic dicarboxylic acids like; dimer acids, dodecane dicarboxylic acid, adipic acid, azelaic acid in the event a carbonate copolymer or interpolymer rather than a homopolymer is desired for use in the preparation of the polycarbonate mixtures of the invention. Most preferred are aliphatic C5 to C12 diacid copolymers.

The preferred polycarbonates are preferably high molecular weight aromatic carbonate polymers have an intrinsic viscosity (as measured in methylene chloride at 25° C.) ranging from about 0.30 to about 1.00 dl/gm. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

The preferred articles of the invention will produce optical storage devices having the following desired characteristics: Visible light transmission as measured by ASTM method D1003, will be greater than or equal to 75%, most preferred above 85%. In-Plane Birefringence (IBR) will be from −100 to +100 nanometers (nm). Vertical Birefringence (VBR) will be less than or equal to 300×10−6. The stress optical coefficient (Cg) will be less than or equal to 70 Brewsters. The glass transition temperature of the preferred blend will be from 80 to 180° C. with the range of 90-150° C. most preferred. A flexural modulus (as measured by ASTM method D790) at room temperature of greater than or equal to 150,00 psi is preferred, with a flexural modulus of greater than or equal to 250,000 psi being more preferred. The yellowness index (YI) will be less than 10, preferably less than 5 as measured by ASTM method D1925. Haze, as measured by ASTM method D1003, will be below 1% in the preferred composition.

Articles of the invention for optical storage of data can be of any type with compact discs (CD), digital video disc (DVD), magneto optical discs being most preferred. Devices can also be recordable and rewritable optical data storage media. In the most preferred devices a reflective metal layer is attached directly to the resin blend substrate where the metal is aluminum, gold or silver. The substrate will have a plurality of pits or depressions to encode data. The data will be read from the optical recording device by a laser.

### EXAMPLES

The following examples serve to illustrate the invention but are not intended to limit the scope of the invention.

A solution composition containing a PC/PCCD composition (95:5 or 90:10) dissolved in a solvent is cast on a substrate to be formed into a film. As the solvent, preferably methylene chloride, or any high polar organic solvent (THF, dioxolane), may be used. Dissolving 15 to 40 parts of said composition into methylene chloride forms the solution (dope). The dope is casted through a solvent cast-die on a belt with a highly polished surface. The film is removed from the belt and dried to a certain volatile content. A pre-drying step is sometimes necessary to reach a desired volatile concentration (less than 1 wt %).

Blend of PCCD with BPA-PC were prepared and various stabilizers were added to give good color and melt stability. The extruded film showed much lower birefringence (20 nm at 30% PCCD) than pure PC (500 nm).

A PC/PCCD composition (90:10) was dissolved in methylene chloride to provide a 25 wt % solution. During the dissolving phase the temperature was kept at 35° C. and the viscosity measured (at RT) was between 5000 and 8000 centi poise. The solution was cast through a solvent cast-die on a stainless steel belt and dried. The film which contains >25 wt % solvent had a width of approximately 1400 mm and was continuously send through a hot-air oven and captured on a roll. The volatile concentration of the dried film was less than 2 wt %. Its thickness was 75micron and the film was free from gels and carbonified material.

What is claimed is:

1. A solvent cast low birefringence substrate or film of optical quality comprises a blend of a cycloaliphatic polyester and a polycarbonate

2. A solvent cast low birefringence substrate or film of optical quality of claim 1 comprising a blend of cycloaliphatic polyester and polycarbonate with in plane birefringence from −100 to +100 nm.

3. A solvent cast low birefringence substrate or film of optical quality of claim 1 with vertical birefringence less than or equal to 300×10−6.

4. A solvent cast low birefringence substrate or film of optical quality of claim 1 where the blend has % transmittance of greater than or equal to 75%.

5. A solvent cast low birefringence substrate or film of optical quality of claim 1 where the blend has a glass transition temperature of from about 90 to 150° C.

6. A solvent cast low birefringence substrate or film of optical quality of claim 1 where the cycloaliphatic polyester is comprised of cycloaliphatic diacid and cycloaliphatic diol units.

7. A solvent cast low birefringence substrate or film of optical quality of claim 1 where the polyester is polycyclohexane dimethanol cyclohexane dicarboxylate (PCCD).

8. A solvent cast low birefringence substrate or film of optical quality of claim 1 where the polycarbonate is composed primarily of the following structural units: bisphenol A, spiro biindane bisphenol, an aryl substituted bisphenol, a cycloaliphatic bisphenol or mixtures thereof.

9. A solvent cast low birefringence substrate or film of optical quality of claim 1 where the polycarbonate is BPA-PC and the cycloaliphatic polyester is PCCD.

10. A solvent cast low birefringence substrate or film of optical quality of claim 1 where the ratio of cycloaliphatic polyester to polycarbonate in the blend is 40:60 to 5:95

11. A solvent cast low birefringence substrate or film of optical quality of claim 1 comprising a blend of a cycloaliphatic polyester and a polycarbonate wherein said polycarbonate comprises a spiro biindane bisphenol.

12. A solvent cast low birefringence substrate or film of optical quality of claim 1 wherein said polycarbonate is composed primarily of the following structural units: bisphenol A, spiro biindane bisphenol, an aryl substituted bisphenol, a cycloaliphatic bisphenol or mixtures thereof.

13. A method of solvent casting comprising preparing a solvent containing dissolved cycloaliphatic polyester and a polycarbonate, casting said solvent onto a support and evaporating the solvent to form a substrate or film.
